(19) United States
(12) Patent Application Publication
(10) Pub. No.: US 2005/0024329 A1
(43) Pub. Date: Feb. 3, 2005

(54) Method and device for cursor control

(76) Inventor: Huo-Lu Tsai, Taichung Hsien (TW)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 10/627,925

(22) Filed: Jul. 28, 2003

(51) Int. Cl. G09G 5/08

(52) U.S. Cl. 345/157

(57) ABSTRACT

A pointing device for cursor control includes a substrate formed with a plurality of switch contacts including direction contacts and a common contact unit. A bridging contact bridges the direction contacts with the common contact unit according to magnitude and direction of an applied external force. A processing unit is connected electrically to the switch contacts, determines a net X vector component and a net Y vector component in accordance with connected and disconnected states of the direction contacts, and multiplies each of the net X and Y vector components by a scaling factor that is selected based on the number of the direction contacts in the connected state to obtain x and y displacement values, respectively. Cursor control signals for repositioning a cursor on a display screen are then generated based on the x and y displacement values.

### BACKGROUND OF THE INVENTION

1. Field of the Invention

The invention relates to a method and device for cursor control, more particularly to a cursor control method and device that is relatively simple and inexpensive to implement while having a relatively fast response time.

2. Description of the Related Art

Apart from computer mice that are widely used as pointing devices for the control of the direction and speed of cursor movement, there is another conventional pointing device to be exerted with an external pressing force for controlling the direction and speed of cursor movement.

Referring to FIGS. 1 and 2, the conventional pointing device responsive to an applied external force for cursor control is shown to include a variable resistance sensing unit 41, four capacitors (C1), (C2), (C3), (C4), and a microprocessor (CPU) 42.

The sensing unit 41 includes four force sensing resistors (FSRX+), (FSRX−), (FSRY+), (FSRY−) connected respectively to terminals (INT1), (INT2), (INT3), (INT4) of the microprocessor 42, and having resistances that vary in accordance with magnitude and direction of an applied external force. Each of the capacitors (C1), (C2), (C3), (C4) is connected to a respective one of the force sensing resistors (FSRX+), (FSRX−), (FSRY+), (FSRY−).

In use, when a force is exerted on the sensing unit 41 in any of the directions (X+), (X−), (Y+) and (Y−), the resistances of the resistors (FSRX+), (FSRX−), (FSRY+), (FSRY−) will change accordingly. At the same time, the capacitors (C1), (C2), (C3), (C4) will be charged through a power supply (VCC). When any of the capacitors (C1), (C2), (C3), (C4) has been charged to a threshold value, the microprocessor 42 will execute a corresponding interrupt routine for repositioning a cursor on a display screen with a one unit displacement in a respective associated direction. The relevant capacitor (C1), (C2), (C3), (C4) is then discharged in preparation for a next repositioning operation.

The following are some of the drawbacks associated with the aforesaid pointing device:

1. The force sensing resistors used in the sensing unit 41 are expensive components that result in higher incurred costs.

2. The capacitors (C1), (C2), (C3), (C4) are external components which increase incurred costs and assembly time and which occupy valuable layout space of the pointing device.

3. The pointing device has a slow response time in view of the need to charge and discharge the capacitors (C1), (C2), (C3), (C4) during cursor repositioning.

### SUMMARY OF THE INVENTION

Therefore, the object of the present invention is to provide a method and device for cursor control that can overcome the aforesaid drawbacks associated with the prior art.

According to one aspect of the present invention, there is provided a method of controlling movement of a cursor on a display screen in response to an external force applied by a user. The method comprises:
a) providing a plurality of switch contacts in a pointing device, the switch contacts including a set of direction contacts that are electrically isolated from each other and that respectively have an associated direction, and a common contact unit that is electrically isolated from the direction contacts;
b) providing the pointing device with a bridging contact that is responsive to the external force applied by the user for bridging together at least one of the direction contacts with the common contact unit in accordance with magnitude and direction of the external force;
c) detecting connected and disconnected states of the direction contacts with the common contact unit;
d) determining a net X vector component and a net Y vector component in accordance with the connected and disconnected states of the direction contacts as detected in step c);
e) selecting a scaling factor based on the number of the direction contacts that were detected in step c) to be in the connected state, the scaling factor increasing in magnitude with the number of the direction contacts detected to be in the connected state;
f) multiplying each of the net X vector component and the net Y vector component by the scaling factor to obtain x and y displacement values, respectively; and
g) generating cursor control signals based on the x and y displacement values obtained in step f) for repositioning the cursor on the display screen.

According to another aspect of the present invention, there is provided a pointing device for controlling movement of a cursor on a display screen in response to an external force applied by a user. The pointing device comprises a plurality of switch contacts, a bridging contact, and a processing unit.

The switch contacts include a set of direction contacts that are electrically isolated from each other and that respectively have an associated direction, and a common contact unit that is electrically isolated from the direction contacts.

The bridging contact is responsive to the external force applied by the user for bridging together at least one of the direction contacts with the common contact unit in accordance with magnitude and direction of the external force.

The processing unit is connected electrically to the switch contacts on the substrate. The processing unit detects connected and disconnected states of the direction contacts with the common contact unit, determines a net X vector component and a net Y vector component in accordance with the connected and disconnected states of the direction contacts as detected by the processing unit, and selects a scaling factor based on the number of the direction contacts that were detected by the processing unit to be in the connected state. The scaling factor increases in magnitude with the number of the direction contacts detected to be in the connected state. The processing unit then multiplies each of the net X vector component and the net Y vector component by the scaling factor to obtain x and y displacement values, respectively, and generates cursor control signals based on the x and y displacement values for repositioning the cursor on the display screen.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram of a conventional pointing device for cursor control;

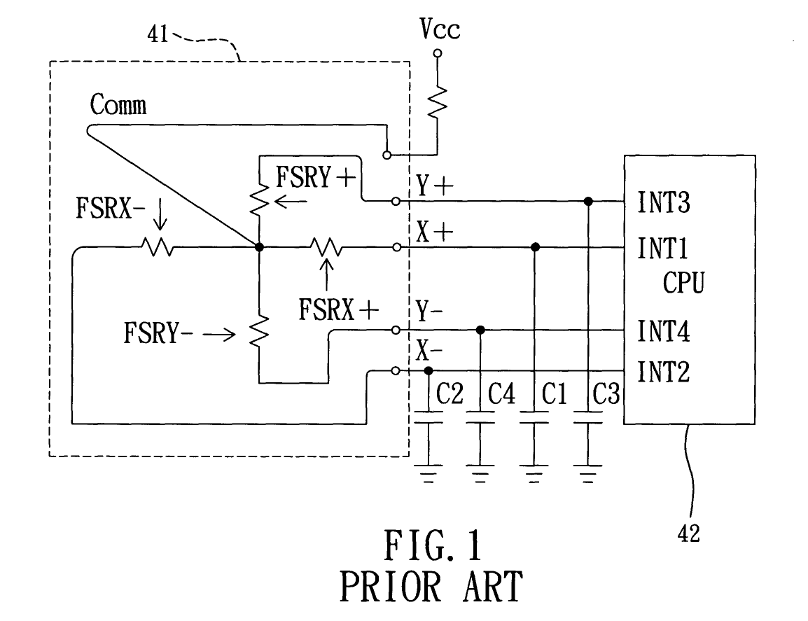

FIG. 2 is a schematic diagram illustrating a variable resistance sensing unit of the conventional pointing device;

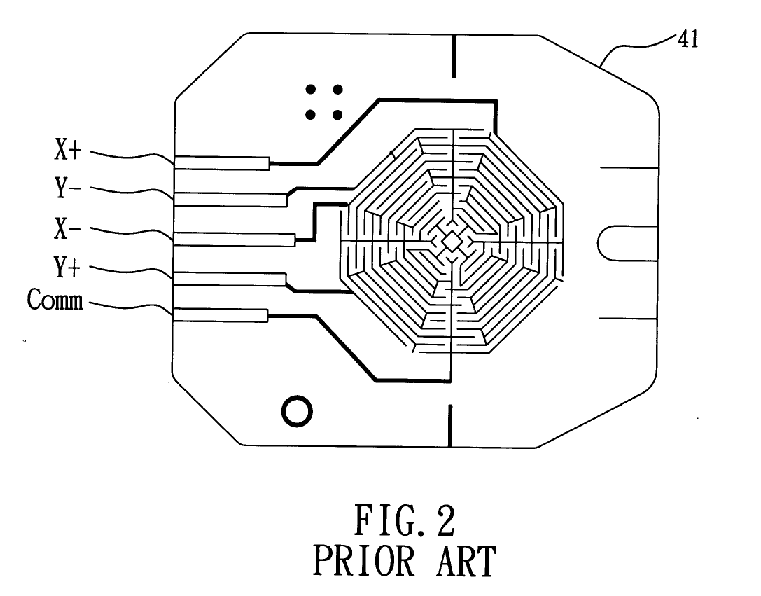

FIG. 3 is a perspective view showing the preferred embodiment of a pointing device according to this invention;

FIG. 4 is a flowchart illustrating consecutive steps performed by a processing unit according to the preferred embodiment of a method for cursor control of the present invention;

FIG. 5 is a schematic sectional view illustrating a press button and a substrate of the preferred embodiment;

FIG. 6 is a schematic wiring diagram illustrating switch contacts on the substrate of the preferred embodiment;

FIG. 7 is a schematic electrical circuit diagram of the preferred embodiment; and

FIG. 8 is a schematic diagram to illustrate how vector components are determined in the preferred embodiment.

### DETAILED DESCRIPTION OF THE PREFERRED EMBODIMENT

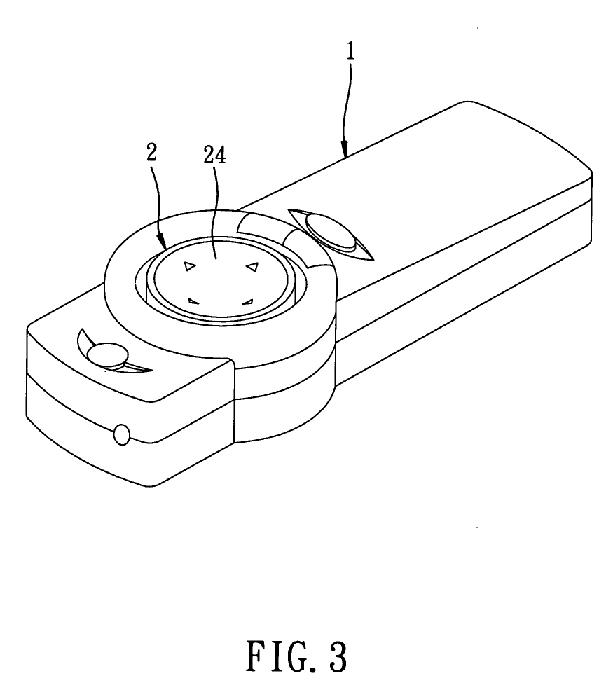

Referring to FIG. 3, the preferred embodiment of a pointing device 2 for cursor control according to the present invention is shown to be incorporated in a handheld remote instruction device 1 for a computer-based visual presentation system (not shown). The pointing device 2 is used for controlling movement of a cursor on a display screen of the visual presentation system in response to an external force applied by a user.

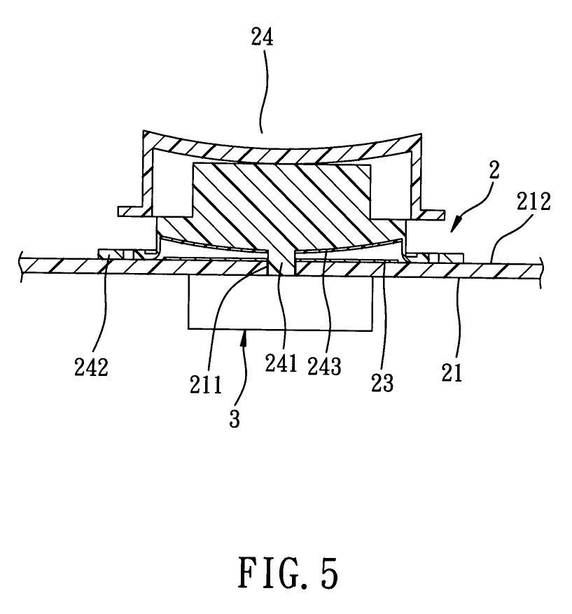

With further reference to FIGS. 5 to 7, the pointing device 2 includes a substrate 21 formed with a through hole 211 and having a top side 212, a press button 24 mounted operably on the top side 212 of the substrate 21, and a processing unit 3 mounted beneath the substrate 21.

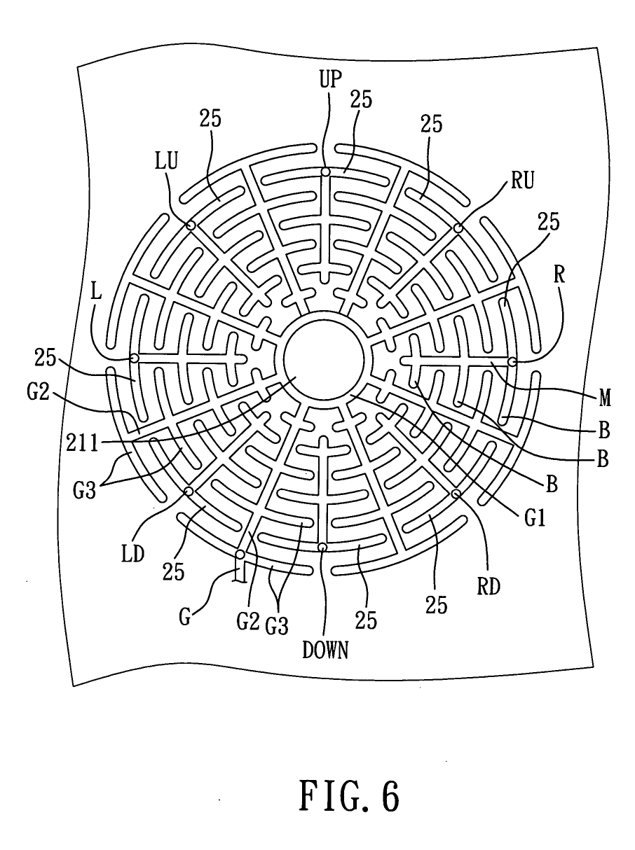

The top side 212 of the substrate 21 is formed with a plurality of switch contacts 23. In this embodiment, the switch contacts 23 are in the form of a copper-platinum printed circuit. As best shown in FIG. 6, the switch contacts 23 include a set of direction contacts 25 that are electrically isolated from each other and that respectively have an associated direction, and a common contact unit (G) that is electrically isolated from the direction contacts 25. In this embodiment, there are eight direction contacts 25 that are spaced apart from each other by 45-degree angles and that are respectively associated with eight contact points, namely (R), (RU), (UP), (LU), (L), (LD), (DOWN) and (RD). Each of the direction contacts 25 includes a trunk section (M) that extends in a respective radial direction relative to the through hole 211, and a set of branch sections (B) that extend in circumferential directions relative to the through hole 211 and that intersect the trunk section (M). The common contact unit (G) includes a central ring portion (G1) co-axial with the button axis, and a plurality of angularly spaced-apart trunk portions (G2) that extend radially from the ring portion (G1). Each of the trunk portions (G1) is disposed between a respective adjacent pair of the direction contacts 25. The common contact unit (G) further includes a plurality of branch portions (G3), each of which extends in a circumferential direction relative to the through hole 211 and intersects a respective one of the trunk portions (G2).

The press button 24 is disposed to receive the external force applied by the user. As best shown in FIG. 5, the press button 24 includes a button stud 241 that defines a button axis transverse to the substrate 21 and that extends into the through hole 211, and a peripheral flange 242 supported by the top side 212 of the substrate 21. The press button 24 is further provided with a bridging contact 243 for bridging together at least one of the direction contacts 25 with the common contact unit (G) in accordance with magnitude and direction of the external force applied by the user. In this embodiment, the bridging contact 243 is a conductive carbon film that is spaced apart from the switch contacts 23 so as not to touch the switch contacts 23 when the external force is not applied on the press button 24.

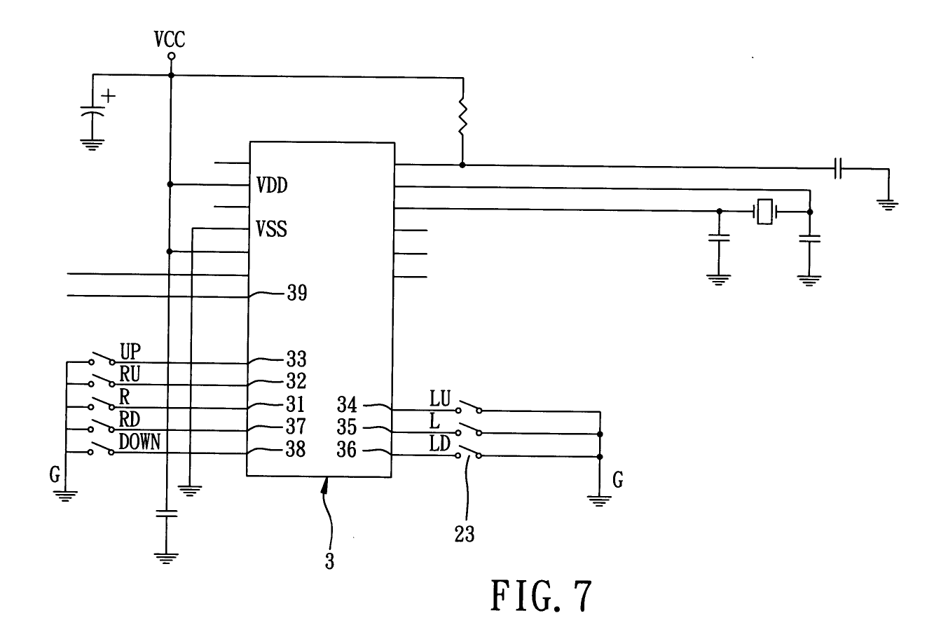

The processing, unit 3 has a signal output terminal 39, and eight input terminals 31, 32, 33, 34, 35, 36, 37, 38 connected electrically and respectively to the direction contacts 25 on the substrate 21, as best shown in FIGS. 6 and 7. When any one of the direction contacts 25 is disconnected from the common contact unit (G), the processing unit 3 will detect a high logic level at the corresponding one of the input terminals 31-38. On the other hand, when any one of the direction contacts 25 is connected to the common contact unit (G), which is grounded, the processing unit 3 will detect a low logic level at the corresponding one of the input terminals 31-38.

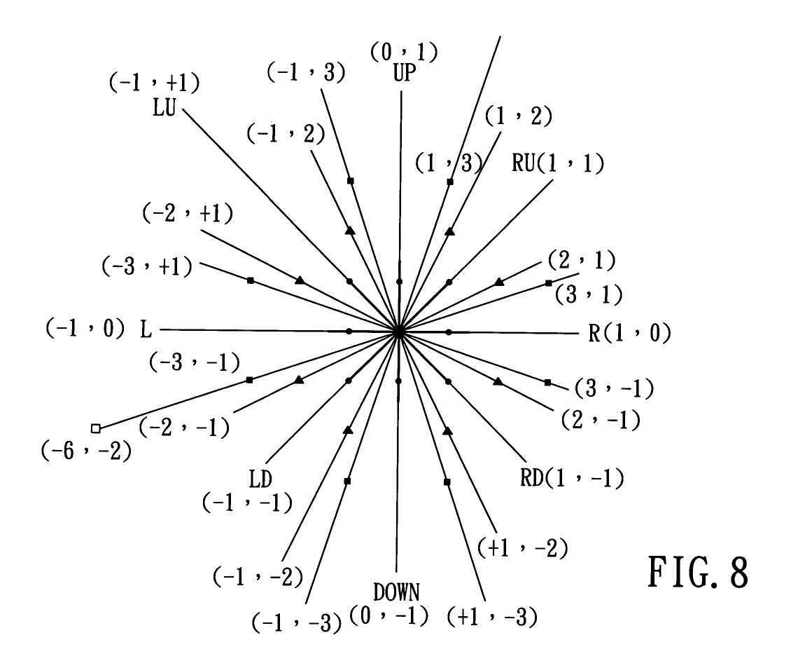

The processing unit 3 defines eight vector values (Xi, Yi), where i ranges from 1 to 8, for the contact points (R), (RU), (UP), (LU), (L), (LD), (DOWN) and (RD), respectively. As best shown in FIG. 8, the vector values for the contact points (R), (RU), (UP), (LU), (L), (LD), (DOWN) and (RD) are (1, 0), (1, 1), (0,1), (−1, 1), (−1, 0), (−1, −1), (0, −1), (1, −1), respectively. In this embodiment, the processing unit 3 further defines a scaling factor that is equal to 1 when the number of the direction contacts 25 detected to be in the connected state ranges from 1 to 3, that is equal to 2 when the number of the direction contacts 25 detected to be in the connected state is equal to 4, that is equal to 3 when the number of the direction contacts 25 detected to be in the connected state is equal to 5, and that is equal to 4 when the number of the direction contacts 25 detected to be in the connected state is equal to 6. In other words, the scaling factor increases in magnitude with the number of the direction contacts 25 detected to be in the connected state.

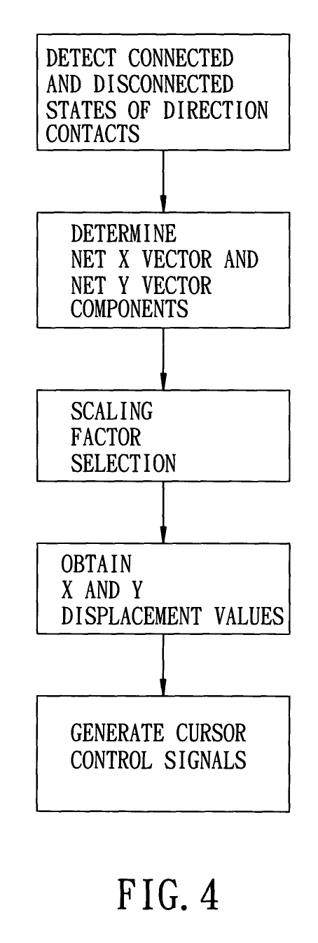

In use, when the press button 24 of the pointing device 2 receives an external force applied by the user, the bridging contact 243 of the press button 24 bridges together at least one of the direction contacts 25 with the common contact unit (G) in accordance with the magnitude and direction of the external force applied by the user. The larger the magnitude of the applied external force, the greater will be the number of the direction contacts 25 bridged to the common contact unit (G). Thereafter, with reference to FIG. 4, the processing unit 3 executes the following steps of a method of controlling movement of a cursor on a display screen in response to the external force applied by the user:

1. Detecting connected and disconnected states of the direction contacts 25 with the common contact unit (G): When the processing unit 3 detects a low logic level at any of the input terminals 31-38, the direction contact 25 corresponding to that terminal is sensed to be in a connected state.

2. Determining a net X vector component and a net Y vector component in accordance with the connected and disconnected states of the direction contacts 25 as detected by the processing unit 3: As shown in FIG. 8, when the processing unit 3 detects the contact points (RU) and (R) to be simultaneously connected to the common contact unit (G), the net X vector component and the net Y vector component are determined to be 2 and 1, respectively, from the sum of the vector values associated with the contact points (RU) and (R). In a similar manner, seven other sets of net X and Y vector components, namely (1, 2), (−1, 2), (−2, 1), (−2, −1), (−1, −2), (1, −2) and (2, −1), can be obtained from the sum of the vector values associated with other adjacent pairs of the contact points.

Moreover, when the processing unit 3 detects the contact points (LU), (UP), (RU) and (R) to be simultaneously connected to the common contact unit (G), the net X vector component and the net Y vector component are determined to be 1 and 3, respectively, from the sum of the vector values associated with the contact points (LU), (UP), (RU) and (R). In a similar manner, seven other sets of net X and Y vector components, namely (−1, 3), (−3, 1), (−3, −1), (−1, −3), (1, −3), (3, −1) and (3, 1), can be obtained from the sum of the vector values associated with other sets of four adjacent ones of the contact points.

3. Selecting a scaling factor based on the number of the direction contacts 25 that were detected by the processing unit 3 to be in the connected state: As mentioned hereinbefore, the scaling factor is equal to 1 when the number of the direction contacts 25 detected to be in the connected state ranges from 1 to 3, is equal to 2 when the number of the direction contacts 25 detected to be in the connected state is equal to 4, is equal to 3 when the number of the direction contacts 25 detected to be in the connected state is equal to 5, and is equal to 4 when the number of the direction contacts 25 detected to be in the connected state is equal to 6.

4. Multiplying each of the net X vector component and the net Y vector component by the scaling factor to obtain x and y displacement values, respectively: When four of the direction contacts 25 are simultaneously connected to the common contact unit (G), the scaling factor is equal to 2. Based on the sets of the net X and Y vector components listed in the aforesaid step (2), the sets of x and y displacement values obtained when four of the direction contacts 25 are in the connected state are (2, 6), (−2, 6), (−6, 2), (−6, −2) (−2, −6), (2, −6), (6, −2) and (6, 2).

5. Generating cursor control signals based on the x and y displacement values for repositioning the cursor on the display screen: For instance, when the processing unit 3 detects the contact points (DOWN), (LD), (L) and (LU) to be simultaneously connected to the common contact unit (G), the resulting set of x and y displacement values is (−6, −2), and the processing unit 3 will generate the appropriate cursor control signals for repositioning the cursor accordingly.

As mentioned hereinabove, the scaling factor increases in magnitude with the number of the direction contacts 25 detected to be in the connected state, which corresponds in turn to the magnitude of the applied external force. Assuming that the user intends to move the cursor rightward, if a weak force is applied to bridge only the contact point (R) to the common contact unit (G), the set of x and y displacement values is (1,0). If a medium force is applied such that the contact points (RU), (R), (RD) are simultaneously bridged to the common contact unit (G), the set of x and y displacement values becomes (3,0). On the other hand, when a strong force is applied such that the contact points (UP), (RU), (R), (RD), (DOWN) are simultaneously bridged to the common contact unit (G), the set of x and y displacement values is (9,0).

It is worthwhile to note that the pointing device 2 of this invention can also be incorporated in a notebook computer or a computer keyboard. Instead of the printed circuit switch contacts and the carbon film bridging contact, it is also feasible to use a thin film switch commonly found in keyboards in the pointing device of this invention. The thin film switch includes superimposed film layers provided with stationary and movable contacts, respectively.

In sum, the pointing device 2 of this invention has the following advantages:

1. Fast cursor movement is possible since cursor displacement depends on the number of the direction contacts 25 detected to be in the connected state, which corresponds in turn to the strength of the applied external force.

2. As compared to force sensing resistors, the switch contacts 23 used in the pointing device 2 are simple and inexpensive, thereby resulting in lower costs.

3. External charge-discharge capacitor components are not required such that the manufacturing process is simplified, and such that the total size of the pointing device 2 is reduced as well.

4. Because there is no need for capacitor charge and discharge operations during cursor repositioning in the pointing device 2 of this invention, a faster response time is possible in the method and device of the present invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A method of controlling movement of a cursor on a display screen in response to an external force applied by a user, the method comprising:
a) providing a plurality of switch contacts in a pointing device, the switch contacts including a set of direction contacts that are electrically isolated from each other and that respectively have an associated direction, and a common contact unit that is electrically isolated from the direction contacts;
b) providing the pointing device with a bridging contact that is responsive to the external force applied by the user for bridging together at least one of the direction contacts with the common contact unit in accordance with magnitude and direction of the external force;
c) detecting connected and disconnected states of the direction contacts with the common contact unit;
d) determining a net X vector component and a net Y vector component in accordance with the connected and disconnected states of the direction contacts as detected in step c);
e) selecting a scaling factor based on the number of the direction contacts that were detected in step c) to be in the connected state, the scaling factor increasing in magnitude with the number of the direction contacts detected to be in the connected state;
f) multiplying each of the net X vector component and the net Y vector component by the scaling factor to obtain x and y displacement values, respectively; and
g) generating cursor control signals based on the x and y displacement values obtained in step f) for repositioning the cursor on the display screen.

2. The method according to claim 1, wherein the pointing device is provided with eight of the direction contacts that are angularly spaced apart from each other.

3. The method according to claim 2, wherein:
the scaling factor is equal to 1 when the number of the direction contacts detected to be in the connected state ranges from 1 to 3;
the scaling factor is equal to 2 when the number of the direction contacts detected to be in the connected state is equal to 4;
the scaling factor is equal to 3 when the number of the direction contacts detected to be in the connected state is equal to 5; and
the scaling factor is equal to 4 when the number of the direction contacts detected to be in the connected state is equal to 6.

4. A pointing device for controlling movement of a cursor on a display screen in response to an external force applied by a user, said pointing device comprising:
a plurality of switch contacts including a set of direction contacts that are electrically isolated from each other and that respectively have an associated direction, and a common contact unit that is electrically isolated from said direction contacts;
a bridging contact responsive to the external force applied by the user for bridging together at least one of said direction contacts with said common contact unit in accordance with magnitude and direction of the external force; and
a processing unit connected electrically to said switch contacts on said substrate, said processing unit
detecting connected and disconnected states of said direction contacts with said common contact unit,
determining a net X vector component and a net Y vector component in accordance with the connected and disconnected states of said direction contacts as detected by said processing unit,
selecting a scaling factor based on the number of said direction contacts that were detected by said processing unit to be in the connected state, the scaling factor increasing in magnitude with the number of said direction contacts detected to be in the connected state,
multiplying each of the net X vector component and the net Y vector component by the scaling factor to obtain x and y displacement values, respectively, and
generating cursor control signals based on the x and y displacement values for repositioning the cursor on the display screen.

5. The pointing device of claim 4, further comprising a substrate formed with said switch contacts, and a press button adapted for receiving the external force applied by the user, said press button being disposed adjacent to said substrate and being provided with said bridging contact.

6. The pointing device of claim 5, wherein said press button defines a button axis transverse to said substrate,
each of said direction contacts including a trunk section that extends in a respective radial direction relative to the button axis, and at least one branch section that extends in a circumferential direction relative to the button axis and that intersects said trunk section,
said common contact unit including a central ring portion co-axial with the button axis, and a plurality of angularly spaced apart trunk portions that extend radially from said ring portion, each of said trunk portions being disposed between a respective adjacent pair of said direction contacts, said common contact unit further including a plurality of branch portions, each of which extends in a circumferential direction relative to the button axis and intersects a respective one of said trunk portions.

7. The pointing device of claim 6, wherein said substrate is formed with eight of said direction contacts.

8. The pointing device of claim 7, wherein:
the scaling factor is equal to 1 when the number of said direction contacts detected to be in the connected state ranges from 1 to 3;
the scaling factor is equal to 2 when the number of said direction contacts detected to be in the connected state is equal to 4;
the scaling factor is equal to 3 when the number of said direction contacts detected to be in the connected state is equal to 5; and
the scaling factor is equal to 4 when the number of said direction contacts detected to be in the connected state is equal to 6.

9. The pointing device of claim 5, wherein said press button is mounted operably on said substrate, and said bridging contact is a conductive carbon film that is spaced apart from said switch contacts so as not to touch said switch contacts when the external force is not applied on said press button.
